(19) United States
(12) Patent Application Publication
(10) Pub. No.: US 2015/0349828 A1
(43) Pub. Date: Dec. 3, 2015

(54) RADIATION PROOF CASE FOR MOBILE COMUNICATION DEVICE

(71) Applicant: William E. Dyson, III, Washington, DC (US)

(72) Inventor: William E. Dyson, III, Washington, DC (US)

(21) Appl. No.: 14/293,707

(22) Filed: Jun. 2, 2014

(51) Int. Cl. H04B 1/3827; H04M 1/02

(52) U.S. Cl. CPC H04B 1/3838; H04M 1/0279

(57) ABSTRACT

A case for a mobile communication device includes a body shaped and dimensioned for receiving a mobile communication device, the body having interior layers of aluminum foil and gold foil sandwiched between outer layers of plastic.

### BACKGROUND OF THE INVENTION

1. Field of the Invention

The present application is directed to a radiation proof case for mobile communication devices.

2. Description of the Related Art

It is known that mobile communication devices, for example, cell phones, produce electromagnetic fields in the form of radiation. These mobile communication devices are commonly supported from the hip or pocket of a user and held in close proximity to a user's head and/or abdomen when in use.

Cell phones constantly emit radiation through the use of functions keeping track of cell phone towers to maintain an available communication channel. And of course illegal spyware and other tracking software cause cell phones to become active without the owner's knowledge thereby producing more harmful radiation. The electromagnetic fields resulting from these transmissions produce a deadly form of radiation, which over a period of time is known to cause cancer.

For years there have been many reports of this unseen danger. These dangers have been rebutted by cell phone and other wireless companies. Yet reports of cancer are on the rise, particular, cancer relating to the panaceas and other human organs. Nothing, however, has really been done to combat the problem of cell phones.

### SUMMARY OF THE INVENTION

It is, therefore, an object of the present invention to provide a case for a mobile communication device. The case includes a body shaped and dimensioned for receiving a mobile communication device, the body having interior layers of aluminum foil and gold foil sandwiched between outer layers of plastic.

It is also an object of the present invention to provide a case wherein the body has an inner surface shaped and dimensioned for direct engagement with a housing of the mobile communication device and an exterior surface contoured for comfortable engagement.

It is another object of the present invention to provide a case wherein the case is constructed with a one-piece body.

It is a further object of the present invention to provide a case wherein the aluminum foil layer and the gold foil layer are removed in those areas adjacent an antenna/transceiver of the mobile communication device.

It is also an object of the present invention to provide a case wherein the body of the case is shaped and dimensioned to cover a lower portion of a housing of a mobile communication device.

It is another object of the present invention to provide a case wherein the body of the case includes a first side wall member, a second side wall member, and a base member connecting the first side wall member to the second side wall member.

It is a further object of the present invention to provide a case wherein each of the first side wall member, the second side wall member, and the base member has a U-shaped cross sectional profile.

It is also an object of the present invention to provide a case further including an engagement strap for positioning about an upper portion of the mobile communication device.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an exploded view showing the mobile communication device and a case in accordance with a first embodiment.

FIG. 2 is a cross sectional view along the line 2-2 in FIG. 1.

FIG. 3 is an exploded view showing the mobile communication device and a case in accordance with a second embodiment.

FIG. 4 is a cross sectional view along the line 4-4 in FIG. 3.

FIG. 5 is a cross sectional view along the line 5-5 in FIG. 3.

FIG. 6 is a cross sectional view along the line 6-6 in FIG. 3.

FIGS. 7 and 8 are cross sectional views of cases in accordance with alternate embodiments of the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

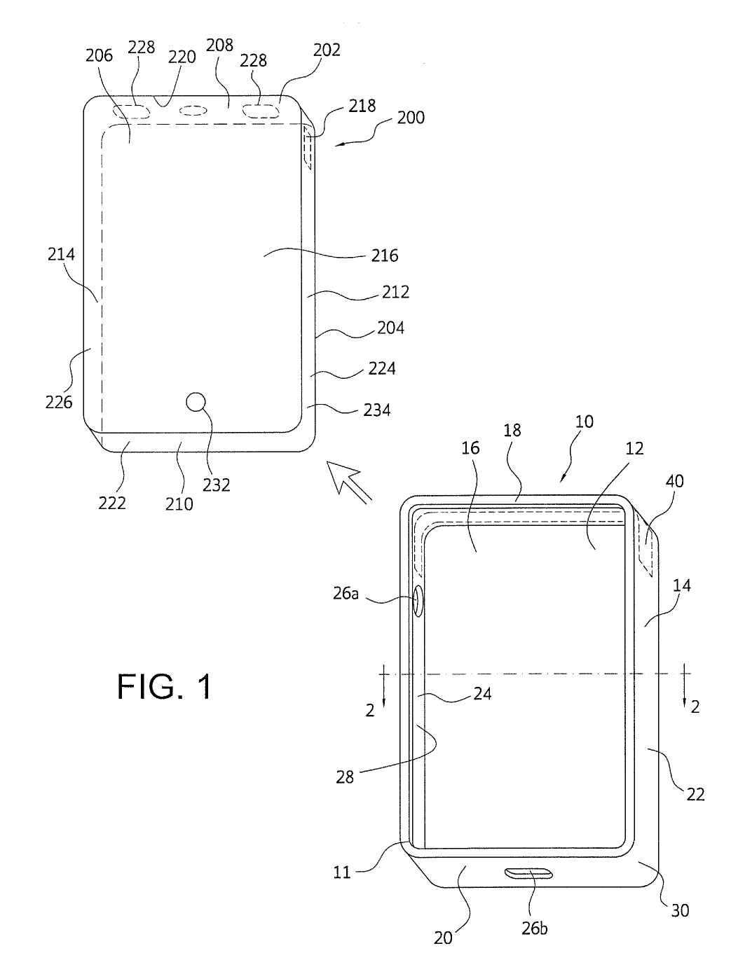

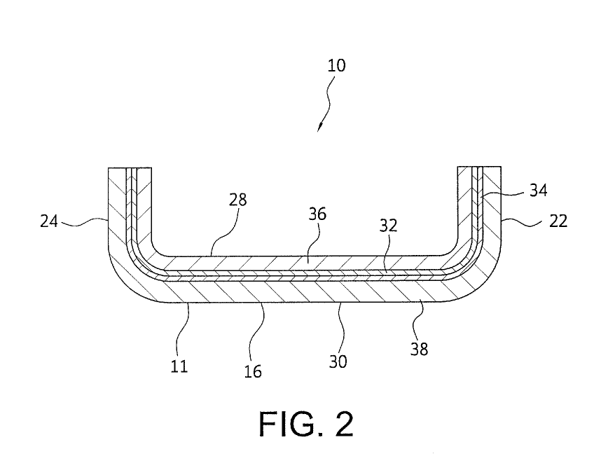

Referring to FIGS. 1 and 2, a radiation proof case 10 for a mobile communication device 200 is disclosed. The case 10 is specifically designed to protect users from radiation emitted by a mobile communication device 200 during use. It is appreciated the term mobile communication device is intended to refer to a wide range of portable communication device facilitating wireless communication over various networks, for example, but not limited to, smartphones, tablets, and other small computer devices allowing for portability and wireless communication with other devices.

As those skilled in the art will appreciate, and by way of example, the mobile communication device 200 includes a housing 202 having a back side 204 and a front side 206 with side walls 208, 210, 212, 214 extending therebetween. The front side 206 is provided with a touch screen 216 for manipulation by a user of the mobile communication device 200. By way of reference, the side walls include a top side wall 208, a base side wall 210 and first and second lateral side walls 212, 214 extending between the top side wall 208 and the base side wall 210.

The case 10 of the present invention is adapted for selective attachment to the housing 202 of the mobile communication device 200 so as to cover the back side 204 and side walls 208, 210, 212, 214 thereof. The case 10 includes a body 11 having an inner surface 12 shaped and dimensioned for direct engagement with the housing 202 of the mobile communication device 200 and an exterior surface 14 contoured for comfortable engagement with the hand, or other body part, of a user.

The case 10, that is, the body 11 of the case 10, includes a substantially planar base 16 from which side walls 18, 20, 22, 24 extend. The side walls 18, 20, 22, 24 are designed to assist in attaching the mobile communication device 200 to the case 10. The side walls 18, 20, 22, 24 extend about the perimeter of the base 16 and are shaped and dimensioned to engage the edges of the mobile communication device 200 for selectively securing the case 10 to the mobile communication device 200. The base 16 and the side walls 18, 20, 22, 24 are formed with various cut-outs 26a, 26b shaped, dimensioned and positioned for accessing various functional components of the mobile communication device 200.

The case 10 also includes an interior surface 28 and an exterior surface 30, which extends along the case 10 so as to define the exposed surfaces of the respective base 16 and the side walls 18, 20, 22, 24. The interior surface 28 is generally flat such that the mobile communication device 200 may be selectively positioned thereupon. That is, the interior surface 28 is shaped and dimensioned for positioning of the back side 204 of the mobile communication device 200 thereon with the touch screen 216 of the mobile communication device 200 facing upward for access by the user of the mobile communication device 200. The exterior surface 30 is a generally flat surface shaped and dimensioned for engagement by the user of the mobile communication device 200 with one hand as he or she manipulates the touch screen 216 with the other hand.

In accordance with a preferred embodiment, the case 10 is constructed with a one-piece body 11. With reference to the cross sectional view of the body 11 of the case 10 shown in FIG. 2, the body 11 of the case 10 is constructed with a layered structure. In particular, the body 11 of the case 10 includes interior layers of aluminum foil 32 and gold foil 34 sandwiched between outer layers of plastic 36, 38. It is appreciated the gold foil acts as the primary wall for deflecting radiation, while the aluminum foil acts as the secondary wall for deflecting radiation from the user. For years aluminum and gold have been deterrents against most forms of radiation including electromagnetic radiation. Aluminum foil has been known to deflect rays of radiation at a high level. Gold foil will also deflect rays of radiation at a medium level. The combination of the aluminum foil and the gold foil provides complete protection from radiation.

As such, and starting with the interior surface 28, the body 11 of the case 10 includes a plastic layer 36 defining the interior surface 28, an aluminum foil layer 32, a gold foil layer 34, and, finally, a plastic layer 38 defining the exterior surface 30 of the case 10. With the exception of the plastic only areas 40 discussed below, these layers are continuous throughout the body 11 of the case 10.

It is appreciated, mobile communication devices 200 are provided with an antenna/transceiver 218 for the reception and transmission of wireless signals in accordance with standard usage protocols, and the aluminum foil layer 32 and the gold foil layer 34 might interfere with the transmission and reception of such signals. As such, the case 10 is constructed such that the aluminum foil layer 32 and the gold foil layer 34 are removed from the body 11 of the case 10 so as define plastic only areas 40 adjacent the antenna/transceiver 218, through which signals may pass permitting unimpeded operation of the mobile communication device 200. It is appreciated the antenna/transceiver may be at different locations in different mobile communication devices, and cases for various mobile communication devices may be constructed.

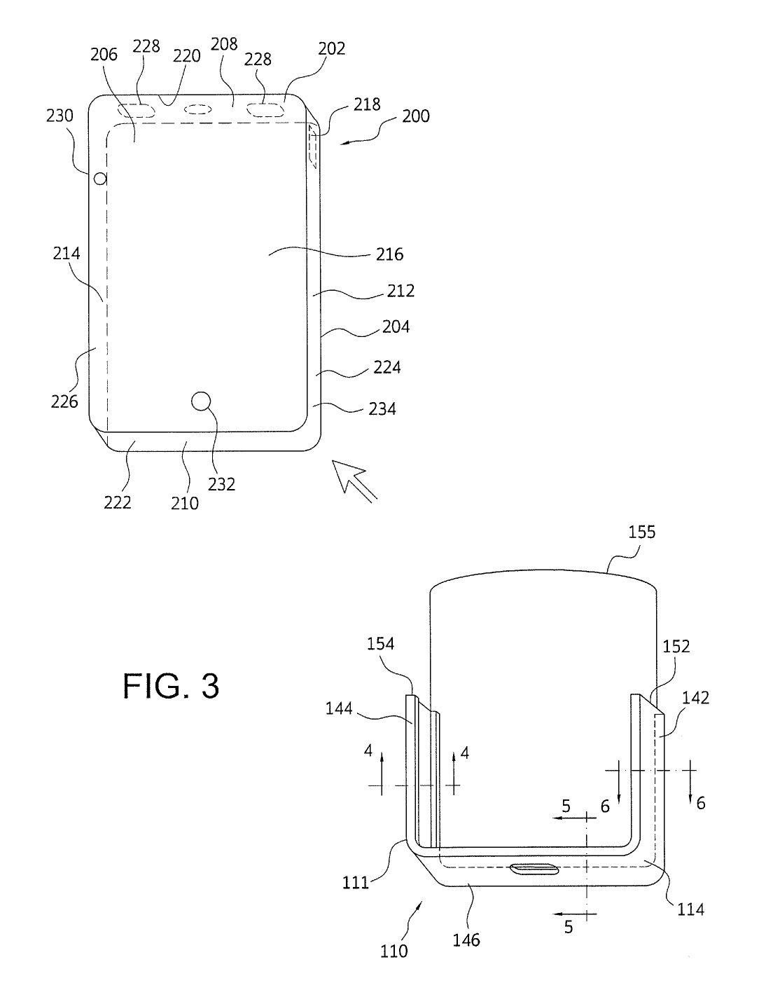

With the problem of potential interference with the antenna/transceiver 218 in mind, and with reference to FIGS. 3 to 6, an alternate embodiment of the case 110 has been developed which will protect the user from harmful radiation while simultaneously allowing for reception and transmission of wireless signals in accordance with standard usage protocols.

As discussed above, the mobile communication device 200 includes a housing 202 having a back side 204 and a front side 206 with sidewalls 208, 210, 212, 214 extending therebetween. The front side 206 is provided with a touch screen 216 for manipulation by a user of the mobile communication device 200. The mobile communication device 200 also includes an antenna/transceiver 218 for the transmission and reception of wireless signals in accordance with standard protocols. For the purposes of explanation it is presumed the mobile communication device 200 is rectangular and, therefore, includes a long axis and a short axis. With this in mind, the mobile communication device 200 includes a first long end 220 and a second long end 222 positioned at opposite ends of the mobile communication device 200 when considered along the long axis thereof. The mobile communication device 200 similarly include a first lateral side 224 and a second lateral side 226 positioned at opposite sides of the mobile communication device 200 when considered across the short axis thereof. The antenna/transceiver 218 and speaker 228 are commonly positioned along an upper portion 230 of the housing 202 of the mobile communication device 200 at a first long end 220 thereof, while the microphone 232 is commonly positioned along a lower portion 234 of the housing 202 of the mobile communication device 200 at the second long end 222 thereof.

The present embodiment is designed to cover the lower portion 234 of the housing 202 of the mobile communication device 200 at the second long end 222 thereof while maintaining exposure of the upper portion 230 of the housing 202 of the mobile communication device 200 at a first long end 220 thereof so as not to interfere with the transmission and reception of signals. As such, the case 110 includes a body 111 that is constructed with a first side wall member 142, a second side wall member 144, and a base member 146 connecting the first side wall member 142 to the second side wall member 144. Each of the first side wall member 142, the second side wall member 144, and the base member 146 has a U-shaped cross sectional profile including a front wall 142f, 144f, 146f, a rear wall 142r, 144r, 146r and a base wall 142b, 144b, 146b connecting the front wall 142f, 144f, 146f to the rear wall 142r, 144r, 146r. With this construction in mind, the body 111 of the case 110 may be secured about the lower portion 234 of the mobile communication device 200 with the first side wall member 142 positioned along the first lateral side wall 212 of the mobile communication device 200, the second side wall member 144 positioned along the second lateral side wall 214 of the mobile communication device 200, and the base member 146 positioned along the base side wall 210 of the mobile communication device 200.

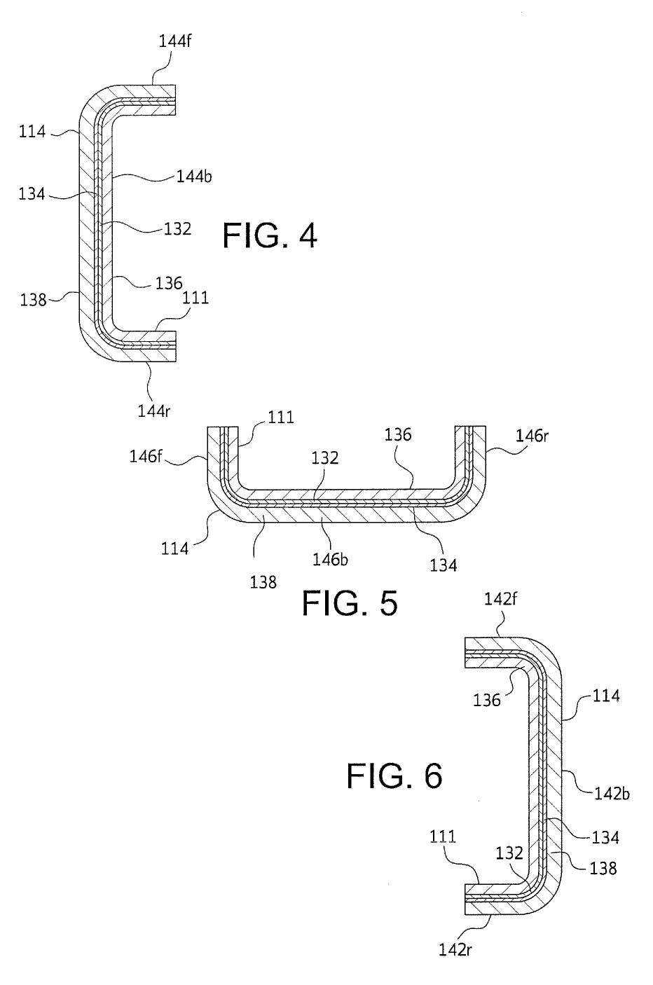

As with the prior embodiment, and with reference FIGS. 4, 5 and 6, the body 111 of the case 110 is constructed with a layered structure. In particular, the body 111 of the case 110 includes interior layers of aluminum foil 132 and gold foil 134 sandwiched between outer layers of plastic 136, 138. As such, and starting with the interior surface 128, the body 111 of the case 110 includes a plastic layer 136 defining the interior surface 128, an aluminum foil layer 132, a gold foil layer 134, and, finally, a plastic layer 138 defining the exterior surface 114 of the case 110. These layers are continuous throughout the body of the case 110.

Given the manner in which a mobile communication device 200 is commonly held, that is, with the lower portion 234 facing the user and the upper portion 230 facing away from the user, the body 111 of the case 110 as applied to the lower portion 234 of the mobile communication device 200 will substantially reduce the radiation to which a user is exposed.

It is appreciated the frictional interaction between the body 111 of the case 110 and mobile communication device 200 might not be sufficient to securely maintain the case 110 in engagement with the mobile communication device 200. With this in mind, the case 110 is provided with an engagement strap 155 for positioning about the upper portion 230 of the mobile communication device 200. The strap 155 extends from the free end 152 of the first side wall member 142 to the free end 154 of the second side wall member 144, and is preferably constructed from an elastic material. In this way, and with the body 111 of the case 110 positioned about the lower portion 234 of the mobile communication device 200, the strap 155 may be extended about the top side wall 208 of the mobile communication device 200 in a manner pulling the case 110 into engagement with the lower portion 234 of the mobile communication device 200.

In the event an elastic strap is not desired, it is appreciated the strap may be a pull strap that frictionally engages the case to allow for adjustment in the length thereof so as to securely position the mobile communication device within the case. Still further, it is contemplated the first side wall member, the second side wall member, and the base member may be constructed to allow for length adjustments for accommodating mobile communication devices of various sizes.

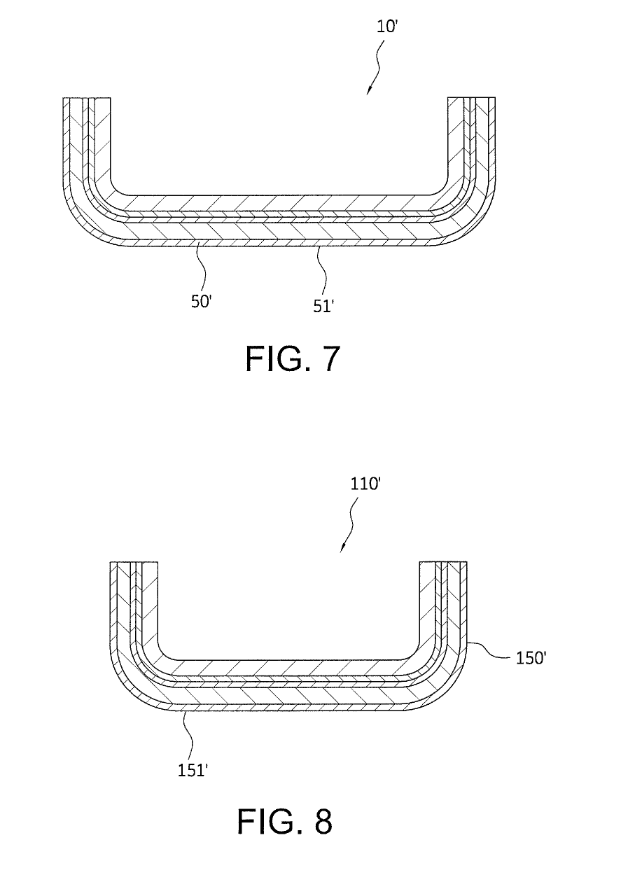

It is further appreciated security features may be incorporated into either the embodiment disclosed with reference to FIGS. 1 and 2 or the embodiment disclosed with reference to FIGS. 3 to 6. Such security features would prevent eavesdropping and video monitoring. Such a security mechanism would shield the camera from the view of others while also preventing others from listening in on conversations through the emission of “white noise”. The security feature would include the use of a soundproofing material from which the case can be manufactured. It is also appreciated both the interior and exterior of the case may be made from the soundproofing material. For example, and with reference to FIGS. 7 and 8, the outer surface 51′, 151′ of the case 10′, 110′ may be covering in a soundproofing material 50′, 150′, while the remaining layers are constructed in accordance with the embodiment described with reference to FIGS. 1 and 2 (see FIG. 7) or constructed in accordance with the embodiment described with reference to FIGS. 3 to 6 (see FIG. 8). As shown, the layering and physical elements of the cases, other than the soundproofing material 50′, 150′, would remain the same as the previously discussed embodiments.

While the preferred embodiments have been shown and described, it will be understood that there is no intent to limit the invention by such disclosure, but rather, is intended to cover all modifications and alternate constructions falling within the spirit and scope of the invention.

1. A case for a mobile communication device, comprising:
a body shaped and dimensioned for receiving a mobile communication device, the body having an interior layers of aluminum foil and gold foil sandwiched between outer layers of plastic.

2. The case according to claim 1, wherein the body has an inner surface shaped and dimensioned for direct engagement with a housing of the mobile communication device and an exterior surface contoured for comfortable engagement.

3. The case according to claim 1, wherein the case is constructed with a one-piece body.

4. The case according to claim 1, wherein the aluminum foil layer and the gold foil layer are removed in those areas adjacent an antenna/transceiver of the mobile communication device.

5. The case according to claim 1, wherein the body of the case is shaped and dimensioned to cover a lower portion of a housing of a mobile communication device.

6. The case according to claim 5, wherein the body of the case includes a first side wall member, a second side wall member, and a base member connecting the first side wall member to the second side wall member.

7. The case according to claim 6, wherein each of the first side wall member, the second side wall member, and the base member has a U-shaped cross sectional profile.

8. The case according to claim 6, further including an engagement strap for positioning about an upper portion of the mobile communication device.
